(19) United States
(12) Patent Application Publication
(10) Pub. No.: US 2019/0092356 A1
(43) Pub. Date: Mar. 28, 2019

(54) Assembly For Monitoring The Occupancy State Of A Switch Or A Track Region

(71) Applicant: SIEMENS AKTIENGESELLSCHAFT, MUENCHEN (DE)

(72) Inventor: FRANK GERTLER, BRAUNSCHWEIG (DE)

(21) Appl. No.: 16/079,318

(22) PCT Filed: Jan. 30, 2017
(86) PCT No.: PCT/EP2017/051914

§ 371 Date: Aug. 23, 2018

(30) Foreign Application Priority Data
Feb. 26, 2016 (DE) 10 2016 203 108.2

(51) Int. Cl. B61L 1/18; B61L 25/02; G01V 3/10

(52) U.S. Cl. CPC B61L 1/181; G01V 3/102; B61L 25/02

(57) ABSTRACT

An assembly for monitoring the occupancy state of a switch or a track region includes a track section configured as a resonant circuit. The resonant circuit contains a rail and an additional rail of the track section with a galvanic bridge on both sides and a capacitor disposed between the rails. The detection behavior for such an assembly is optimized while taking into consideration different lengths of the assembly by providing the assembly with at least one adaptation coil assembly which is placed in a track section compartment formed by the galvanic bridges on both sides and which is connected to a rail-free connection of the capacitor with a single-sided connection to one rail on one side and to the other rail on the other side.

The invention relates to an assembly for monitoring the occupancy state of a switch or a track region comprising a track section which is designed as a resonant circuit, wherein the resonant circuit contains a rail and an additional rail of the track section with a galvanic bridge on both sides and a capacitor arranged between the rails. The resonant circuit is designed as a parallel resonant circuit.

An assembly of this kind is described in the German patent application DE 103 20 680 A1 and represents a jointless track circuit. Such an assembly—also referred to as a “point blocking circuit”—is constructed in lengths of between 3 m and 24 m and during use of the track section with a rail vehicle enables the detection of a resulting attenuation and resonance frequency change.

However, where assemblies and/or track circuits decrease in length, the inductance drops and the resonance resistance of the resonant circuit and the losses increase. This reduces the sensitivity as an induction loop. At the same time, during use with a rail vehicle intervals which can only be detected by the highest possible sensitivity of the induction loop occur without being influenced by the axles of the rail vehicle.

The quality of rail vehicle detection therefore declines in the case of short assemblies, with additional losses as a result of structural environmental conditions such as, for example, reinforcements in the case of a rigid track, exacerbating this problem. In extreme cases, this can therefore result in undesirable idle notifications occurring while in use by a rail vehicle.

On the other hand, due to their large surface area long assemblies display high inductance, and the capacity of the capacitor of the resonant circuit is relatively small, resulting in an increase in climate sensitivity. Furthermore, long assemblies have blurred occupancy and idle notification points in the region of the respective assembly because of uniform field distribution.

The object of the present invention is to optimize the detection behavior of such an assembly, taking into consideration different lengths of the assembly.

To achieve this object, in an assembly of the aforementioned type according to the invention the assembly has at least one adaptation coil assembly which is placed in a track section compartment formed by the galvanic bridges on both sides and which is connected to a rail-free connection of the capacitor with a single-sided connection to one rail on one side and to the other rail on the other side.

A major advantage of the assembly according to the invention is seen in the fact that the use of an adaptation coil assembly in the course of the capacitor between the two rails of the assembly both in short and long assemblies enables the sensitivity of the assembly to be increased and the quality of rail vehicle detection to be considerably enhanced.

In the assembly according to the invention, the adaptation coil assembly can be designed in different ways. Thus, on account of a simple embodiment it is considered advantageous if the adaptation coil assembly comprises a single adaptation coil.

In the case of a short assembly, the single adaptation coil is connected as an extension coil with the end of its section parallel to one rail to the other rail and with the end of its section parallel to the other rail to the rail-free connection of the capacitor.

In the assembly according to the invention, a design of the resonant circuit is particularly preferred in which the adaptation coil assembly comprises at least two electrically parallel extension sub-coils and the ends of the respective sections of the extension sub-coils parallel to one rail are connected to the other rail and the ends of the respective sections of the extension sub-coils parallel to the other rail are connected to the rail-free connection of the capacitor. This embodiment increases the inductance of the assembly according to the invention; it is therefore quasi electrically extended. The resonance resistance rises, counteracting the losses. The sensitivity of the assembly according to the invention increases significantly.

To maximize the effects of the assembly according to the invention as far as possible, the extension coil assembly extends advantageously over the entire compartment of the track section.

In particular, in the case of long assemblies and/or track circuits the assembly according to the invention is advantageously designed such that the single adaptation coil is connected as a shortening coil to the rail-free connection of the capacitor with the end of its section parallel to one rail and to the other rail with the end of its section parallel to the other rail.

In a particularly advantageous embodiment of the assembly according to the invention, the adaptation coil assembly consists of at least two electrically parallel shortening sub-coils with opposing magnetic fields, and the ends of the sections of the shortening sub-coils each parallel to one rail are connected to the rail-free connection of the capacitor and the ends of the sections of the shortening sub-coils each parallel to the other rail are connected to the other rail. In other words, the shortening sub-coils are arranged in series with the capacitor in such a way that they each establish a partial coil field which in each case is directed counter to the rail magnetic field generated by the rails.

In this case, it is particularly advantageous if in the assembly according to the invention the shortening coil assembly extends over a sub-section of the compartment of the track section which is provided by a feed point of a transmitter exciting the resonant circuit and a coupling-out point for an associated receiver. The rail magnetic field is attenuated by the shortening sub-coils in the sub-section of the compartment such that the inductance falls and the magnetic field is concentrated outside the sub-section up to the galvanic bridges in each case such that the occupancy blur is counteracted.

In this context, it is particularly advantageous if in the region of the feed point and the coupling-out point each shortening sub-coil merges into a respective additional coil which in each case is arranged in a further sub-section between the feed point and the decoupling point and the galvanic bridge and generates an additional coil magnetic field while amplifying the magnetic field of the rails. At the further sub-sections, occupancy and idle notifications from the assembly according to the invention can be detected particularly reliably.

For further explanation of the invention,

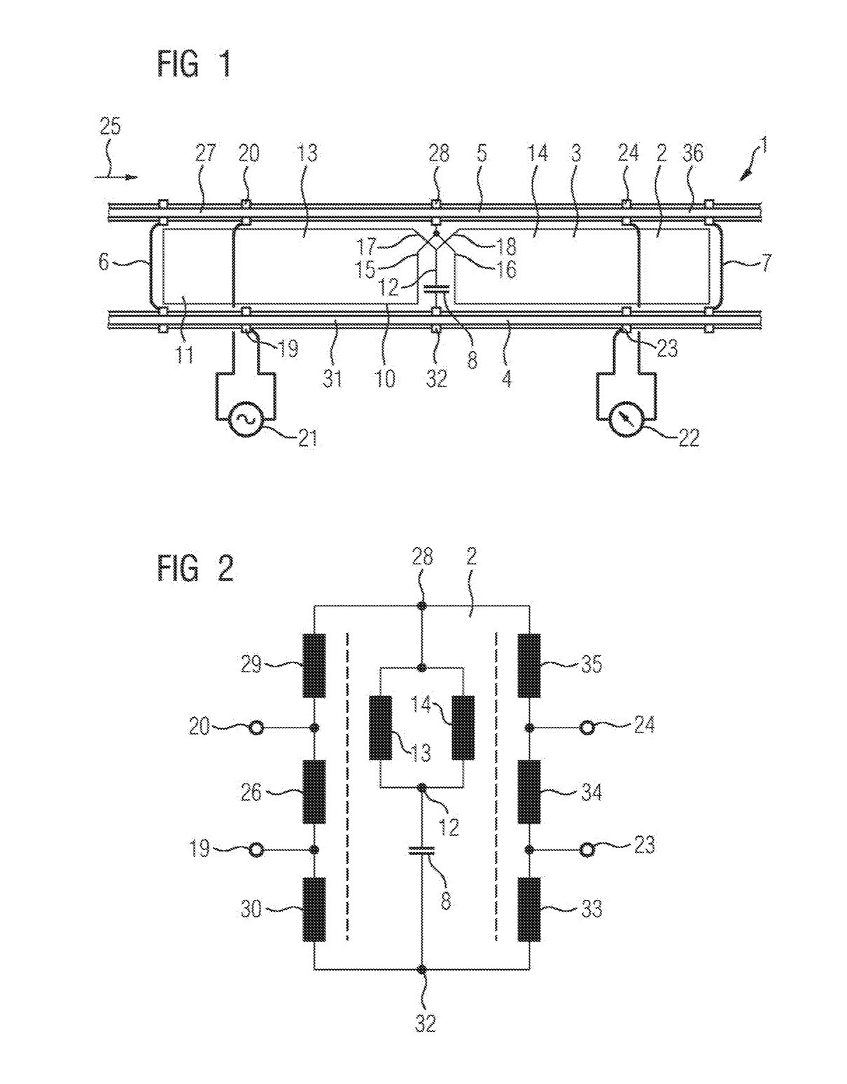

FIG. 1 shows an exemplary embodiment of an assembly according to the invention with two extension sub-coils,

FIG. 2 shows an electrical equivalent circuit diagram of the resonant circuit according to FIG. 1, in

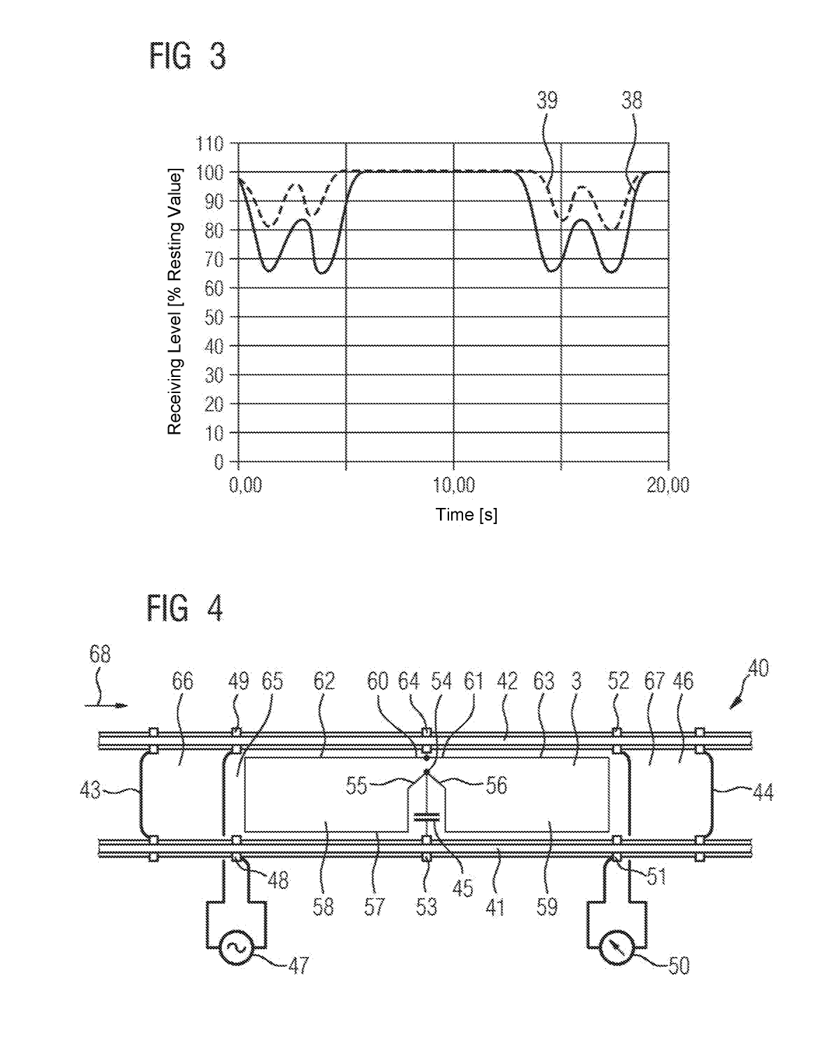

FIG. 3 shows the receiving level when using the exemplary embodiment according to FIG. 1, in

FIG. 4 shows a further exemplary embodiment of an assembly according to the invention with two shortening sub-coils, in

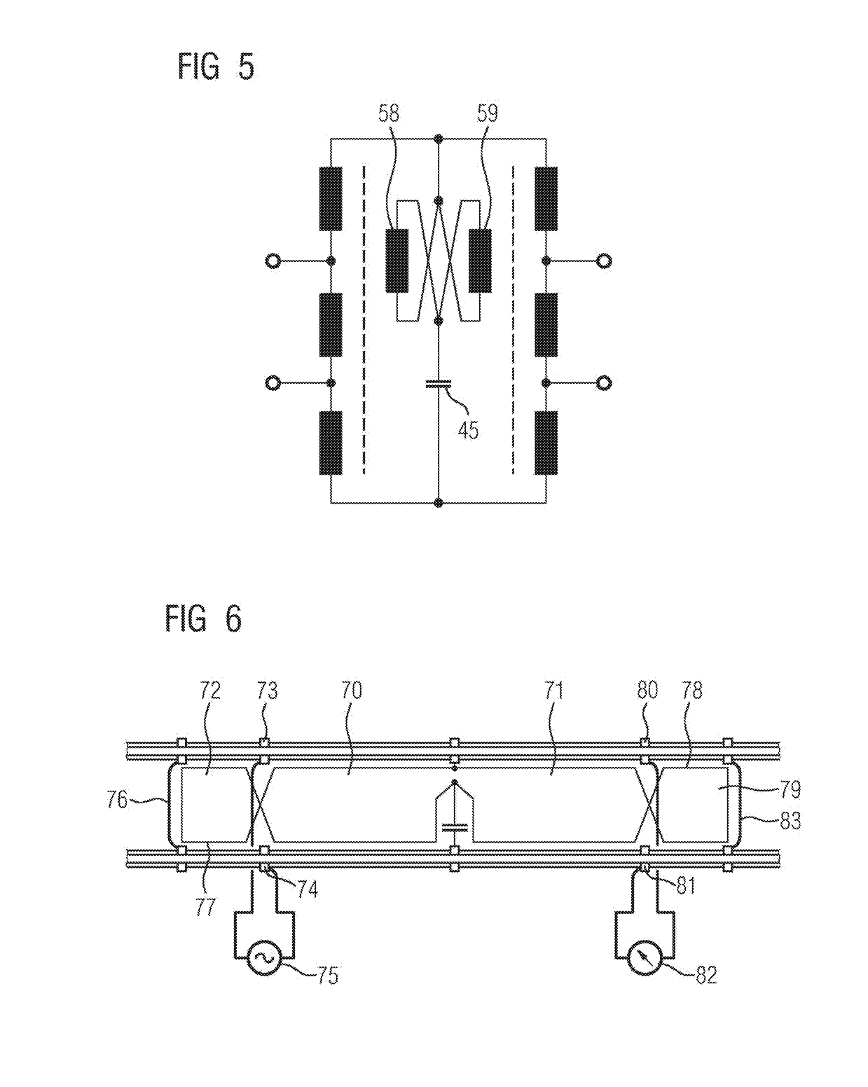

FIG. 5 shows an electrical equivalent circuit diagram of the resonant circuit according to FIG. 4 and in

FIG. 6 shows an additional exemplary embodiment of an assembly according to the invention with two shortening sub-coils and one additional sub-coil each.

The exemplary embodiment according to FIG. 1 shows an assembly 1 for monitoring the occupancy state of a switch not shown. The assembly 1 comprises a track section 3 designed as a resonant circuit 2 which is, for example, only approximately 4.3 meters in length, hence relatively short. The resonant circuit 2 has a rail 4 and an additional rail 5. There is a galvanic bridge 6 and/or 7 on both sides of the track section 3 respectively. A capacitor 8 is arranged between the rails 4 and 5. One rail 4 with the other rail 5 and the capacitor 8 form the resonant circuit 2.

As can further be seen from FIG. 1, the assembly 1 has an adaptation coil assembly 10 which is placed in a compartment 11 of the track section 3 formed by the galvanic bridges 6 and 7 on both sides. The adaptation coil assembly 10 is connected to a rail-free connection 12 of the capacitor 8 on one side, which in turn has a single-sided connection to one rail 4. On the other side, the adaptation coil assembly 10 is directly connected to the other rail 5. The adaptation coil assembly 10 therefore forms part of the resonant circuit 2.

It also emerges from FIG. 1 that the adaptation coil assembly 10 comprises at least two electrically parallel extension sub-coils 13 and 14. In this case, the ends 15 and/or 16 of each of the sections of the extension sub-coils 13 and 14 parallel to one rail 4 are directly connected to the other rail 5. The ends 17 and/or 18 of each of the sections of the extension sub-coils 13 and/or 14 parallel to the other rail 5 are each connected to the rail-free connection 12 of the capacitor 8.

A low-frequency transmitter 21 is connected to a feed point 19 and/or 20; the transmitter 21 has a receiver 22 which is connected to one rail and the other rail 4 and/or 5 at a decoupling point 23 and/or 24. The housing of the extension sub-coils 13 and 14 inside the compartment 11 formed with the galvanic bridges 6 and 7 results in the amplification of the rail magnetic field formed by the rails 4 and 5 with the galvanic bridges 6 and 7 with the aid of the extension sub-coils 13 and 14, leading to an electrical (not actual) extension of the track section 3. This achieves that despite a relatively short embodiment of the assembly 1, a reliable occupancy and/or idle notification can be provided if, for example, a rail vehicle moving in the direction of an arrow 25 and not shown uses the track section 3.

FIG. 2 shows an electrical equivalent circuit diagram of the resonant circuit 2 shown in FIG. 1. It can be seen from FIG. 1 that the equivalent circuit has the two feed points 19 and 20 to which—see FIG. 1—the transmitter 21 is connected. An inductive resistor 26 which corresponds to the partial inductance of one galvanic bridge 6 is thus located between the feed points 20 and 21. A section 27 shown in FIG. 1 of the other rail 5 from the galvanic bridge 6 to a connection point 28 on the other rail 5 forms another inductive resistance 29; in series with the inductive resistance 26 is an additional inductive resistance 30 which is formed by a section 31 of the one rail 4 between the galvanic bridge 6 and a connection point 32.

According to FIG. 2, parallel to the aforementioned elements of the resonant circuit 2 is a further embodiment of inductive resistances 33, 34 and 35 which with regard to the inductive resistance 33 are based on the inductive effect of one rail 4 between the connection point 32 of the capacitor 8 and the galvanic bridge 7, with regard to the inductive resistance 34 on the inductive effect of the galvanic bridge 7 and with regard to the inductive resistance on the inductive effect of a section 36 between the galvanic bridge 7 and the connection 28 of the other rail 5.

As can be clearly seen from FIG. 2, the capacitor 8 of the resonant circuit 2 is connected to the connection 32 on one rail 4 on one side (cf. also FIG. 1) and has the rail-free connection 12 on the other side. The extension sub-coils 13 and 14 are connected to this rail-free connection 12, forming a parallel connection. The end of the parallel connection facing away from the rail-free connection 12 of the capacitor 8 is connected to the connection 28 on the other rail 5.

FIG. 3 shows the behavior of the resonant circuit 2 shown in FIG. 2 when using the track section 3 and reveals that while being used for a period of between 0 and 5 seconds, in an assumed example a change occurs in the receiving level on the receiver 22 according to the representation after the extended curve 38. Then after about 5 seconds a resting value is reached which only changes approximately 15 seconds after the start of usage. At this time, the receiving level has changed again considerably, leading to a reliable idle notification of the track section 3.

For comparison, FIG. 3 shows an additional curve 39 which reproduces the conditions when an adaptation coil assembly and/or the extension sub-coils 13 and 14 are not provided. A clear distinction which shows the improvement with regard to notification of the occupancy state and/or the idle state can be seen.

The exemplary embodiment according to FIG. 4 for a relatively long track section in the order of magnitude of approximately 24 meters in turn shows an assembly 40 with one rail 41 and another rail 42 which form a resonant circuit 46 with a capacitor 45 by means of the galvanic bridges 43 and 44. In this case, a transmitter 47 in the low frequency range is in turn connected to the two rails 41 and 42 at a feed point 48 and 49; an associated receiver 50 is provided at a decoupling point 51 and 52 of the two rails 41 and 42.

In this exemplary embodiment too, the capacitor 45 is not connected directly between the two rails 41 and 42 but is connected to a connection point 53 with one rail 41 on one side and has a rail-free connection 54 on the other side, to which the ends 55 and 56 of the sections 57 of a shortening sub-coil 58 and a further shortening sub-coil 59 parallel to the one rail 41 lead. The ends 60 and 61 of the sections 62 and 63 of the shortening sub-coils 58 and 59 parallel to the other rail 42 are connected to a connection 64 of the other rail 42. The shortening sub-coils 58 and 59 are in a sub-section 65 between the feed points 48 and 49 of the transmitter 47 and/or the decoupling points 51 and 52 of the receiver 50.

Outside this sub-section 65 there is another sub-section 66 and/or 67 as far as the galvanic bridges 43 and 44 in each case. In the other sub-sections 66 and 67, the rail magnet image formed by the rails 41 and 42 with the galvanic bridges 43 and 44 is relatively strong, while in the sub-section 65 it is relatively strongly attenuated. The magnetic field is therefore concentrated in the other sub-sections 66 and 67, counteracting the occupancy blur, in other words, avoiding blurred occupancy and idle notification points.

FIG. 5 shows an equivalent circuit diagram of the resonant circuit 46 according to FIG. 4 and reveals that, contrary to the representation according to FIG. 2, the shortening sub-coils 58 and 59 downstream of the capacitor 45 are here oriented in opposite directions with respect to their magnetic field in relation to the rail magnetic field such that the resulting magnetic field inside one sub-section 65 is attenuated. If a rail vehicle uses the assembly 40 according to FIG. 4 in the direction of an arrow 68 (see FIG. 4), then—similar to what is shown in FIG. 3—a relatively strong level change in the receiver 50 becomes noticeable, permitting a reliable occupancy and idle notification.

The exemplary embodiment according to FIG. 6 largely corresponds to the embodiment according to FIG. 4, but here an additional sub-coil 77 is provided in addition to a shortening sub-coil 70 and another shortening sub-coil 71 in another sub-section 72 between the feed points 73 and 74 for a transmitter 75 and a galvanic bridge 76; this additional sub-coil 77 connects in the opposite direction of winding to one shortening sub-coil 70 and forms an additional coil magnetic field which also amplifies the rail magnetic field.

The same applies with regard to another additional sub-coil 78 in another sub-section 79. The other sub-section 79 is provided by the decoupling points 80 and 81 for the receiver 82 and the galvanic bridge. In the other sub-sections 72 and 79, the rail magnetic field is amplified such that an occupancy and/or idle notification can be detected hereby with particularly high occupancy sharpness.

1-9. (canceled)

10. An assembly for monitoring the occupancy state of a switch or a track region, the assembly comprising:
a track section having a compartment, said track section being configured as a resonant circuit containing:
one rail and an additional rail of said track section,
galvanic bridges each disposed on a respective side of said track section and each forming a respective side of said compartment, and
a capacitor disposed between said rails, said capacitor having a rail-free connection with a single-sided connection to said one rail; and
at least one adaptation coil assembly disposed in said compartment, said at least one adaptation coil assembly having one side connected to said rail-free connection and another side connected to said additional rail.

11. The assembly according to claim 10, wherein said at least one adaptation coil assembly is formed of a single adaptation coil.

12. The assembly according to claim 11, wherein:
said single adaptation coil is an extension coil having a section running parallel to said one rail and a section running parallel to said additional rail,
said section running parallel to said one rail having an end connected to said additional rail; and
said section running parallel to said additional rail having an end connected to said rail-free connection of said capacitor.

13. The assembly according to claim 10, wherein:
said at least one adaptation coil assembly is formed of at least two electrically parallel extension sub-coils having sections parallel to said one rail and sections parallel to said additional rail;
each of said sections parallel to said one rail having ends connected to said additional rail; and
each of said sections parallel to said additional rail having ends connected to said rail-free connection of said capacitor.

14. The assembly according to claim 10, wherein said at least one adaptation coil assembly extends entirely over said compartment of said track section.

15. The assembly according to claim 11, wherein said single adaptation coil is a shortening coil having said end of said section parallel to said one rail connected to said rail-free connection of said capacitor and having said end of said section parallel to said additional rail connected to said additional rail.

16. The assembly according to claim 10, wherein:
said at least one adaptation coil assembly includes at least two electrically parallel shortening sub-coils with opposing magnetic fields;
said shortening sub-coils include sections parallel to said one rail having ends and sections parallel to said additional rail having ends; and
said ends of each of said sections parallel to said one rail are connected to said rail-free connection of said capacitor and said ends of each of said sections parallel to said additional rail are connected to said additional rail.

17. The assembly according to claim 10, which further comprises:
a transmitter exciting said resonant circuit and having a feed point; and
a receiver associated with said transmitter and having a decoupling point;
said at least one adaptation coil assembly being a shortening coil assembly extending over a sub-section of said compartment of said track section defined by said feed point and said decoupling point.

18. The assembly according to claim 17, wherein:
said shortening coil assembly includes additional shortening sub-coils each merging in a region of a respective one of said feed point and said decoupling point into a respective additional sub-coil; and
each additional sub-coil being disposed in a further sub-section between a respective one of said feed point and said decoupling point and a respective one of said galvanic bridges and generating an additional coil magnetic field while amplifying a magnetic field of said rails.
